(19) United States
(12) Patent Application Publication
(10) Pub. No.: US 2003/0101886 A1
(43) Pub. Date: Jun. 5, 2003

(54) Device for providing a cylinder with a packing and registers

(76) Inventor: Volker Gerold Rauh, Hettstadt (DE)

Correspondence Address: Douglas R Hanscom, Jones Tullar & Cooper, P O Box 2266 Eads Station, Arlington, VA, 22202, US

(21) Appl. No.: 10/257,971

(22) PCT Filed: Apr. 4, 2001
(86) PCT No.: PCT/DE01/01307

(30) Foreign Application Priority Data
Apr. 28, 2000 (DE) 100 20 910.6

(51) Int. Cl. B41F 1/28

(52) U.S. Cl. 101/415.1

(57) ABSTRACT

The invention relates to a device for providing a cylinder with a packing and registers. For positioning register-containing packings (8) on the peripheral surface (4) of cylinders (1) of a rotary printing machine, stops or register pins (12) are used on corresponding fitting strips or supports that are fastened in or on the channel (2) that receives the packing. It is disadvantageous to fasten the pins or fitting strips from the channel side if one wishes to obtain channel openings that are as narrow as possible. The aim of the invention is therefore to allow the register stones to be immobilized against axis-parallel changements of positions without the need of accessing them from the peripheral surface of the cylinder. To this end, the position of the register stones can be changed in the axis-parallel direction of the cylinder and the register stones can be held by a clamping device (13) that can be actuated from the front face of the cylinder.

The invention relates to devices in accordance with the preambles of claims 1 or 3 for placing a registry-stable packing on a cylinder.

A lateral registry system for printing formes in an axis-parallel gap of the cylinder is known from DE 42 41 588 C2, wherein cutouts at the beveled ends of the printing forme act together with register pins arranged in the gap. The register pins are rigidly connected with insertion strips, which can be individually axially displaced, arranged axis-parallel above each other in the groove, in respect to each other and in relation to the cylinder. The displacement is performed for the purpose of the lateral adjustment of the printing forme by means of respective threaded bolts arranged at the front face of the cylinder, whose thread length defines the displacement distance.

In a similar way DE 197 57 895 C2 shows a setting arrangement, but wherein the insertion strips are arranged next to each other in the gap, and an increase of the setting range takes place by intermediate positions possible between the strip and the supports of the screw arranged on the front face.

EP 0 490 179 A1 discloses a register element which is releasably arranged on an insertion strip and which is displaceable in relation to the insertion strip fixed on the cylinder by means of eccentric bolts within the range of the eccentricity. For fixation in place against unintentional displacement, the register element, which is provided with elongated holes, is maintained frictionally connected to the bottom of the insertion strip by means of screws. Releasing and clamping, as well as adjustment, is performed from the direction of the cylinder shell through the groove opening. Releasing and clamping takes place in a similar way in EP 0 535 502 B1 radially by means of screws, which are embedded in the insertion strips matched to the curvature of the cylinder shell.

DE 196 00 071 C1 discloses a device for placing a registry-stable packing on the shell surface of a cylinder. Clamping of register blocks takes place, extending from the shell surface, by means of the friction between the end of the register block itself, which is embodied as a conical seat, and a recess in a base body fixed in place on the cylinder body. The register blocks can be inserted discontinuously in the axial direction into various recesses, or base bodies.

A device is known from U.S. Pat. No. 5,419,248, in which substantially ring-shaped register elements are seated, freely rotatable, on an actuating shaft of a clamping device and can each be frictionally fixed in place in the groove by means of a spreading device which can be operated from the groove.

The object of the invention is based on creating devices for the registry-stable placement of a packing on a cylinder.

In accordance with the invention, the object is attained by means of the characteristics of claims 1 or 3.

The advantages which can be achieved by means of the invention reside in particular in that a variable arrangement and number of register elements can be arranged in a groove over almost the entire width of a barrel, or variably within the groove over the width of the printed material web or of the printing forme, regardless whether there is a printing press with two, four or even more printing plates, or printing sides, arranged next to each other in the longitudinal direction.

The axial regulating distance for the register blocks is independent of an axial regulating distance of a regulating spindle or clamping device which can be operated from the front face, and is not fixedly connected with the latter.

The continuous regulating distance, which can be used over almost the entire length of the barrel of the cylinder, or over the width of the printing forme, makes possible, besides an adjustment within a narrow regulating range, for example a rapid reconfiguration of the register elements to other web widths of the paper or other printing formats, for example by simple displacement, without new elements needing to be inserted. The relative, axis-parallel, but independent displacement of two or more register elements in respect to each other is also of great advantage. Particularly advantageous is the simple press- or customer-specific positioning and configuration of the register elements in situ, without having to take narrow basic regulating ranges into consideration already in the course of the manufacture, or assembly, of the grooves, even for different series or models.

For special embodiments, the shaping and dimensions of the device can be matched in a simple manner to groove geometries or register devices of existing printing presses, so that retrofitting or refitting are possible. Also, in connection with already assembled presses, the exchange of register elements of various dimensions, their removal or the additional equipping with them is possible.

It is particularly advantageous for cylinders with narrow, axially extending grooves for receiving printing formes that clamping, or releasing of the register elements takes place from outside of the printing area of the barrel, for example from the direction of the front face of the cylinder. The opening of the groove in the circumferential direction can be kept as narrow as required for inserting printing formes, for example, without having to take possible fastening or adjusting means into consideration, which must be accessible through the groove. The gap width is independent of tools or means for actuating the clamping device. The disruption of the shell surface of the cylinder, and therefore a limitation of the printing area, for example by embedded screws spaced apart from the groove, is avoided.

An exemplary embodiment of the invention is represented in the drawings and will be explained in greater detail in what follows.

Shown are in:

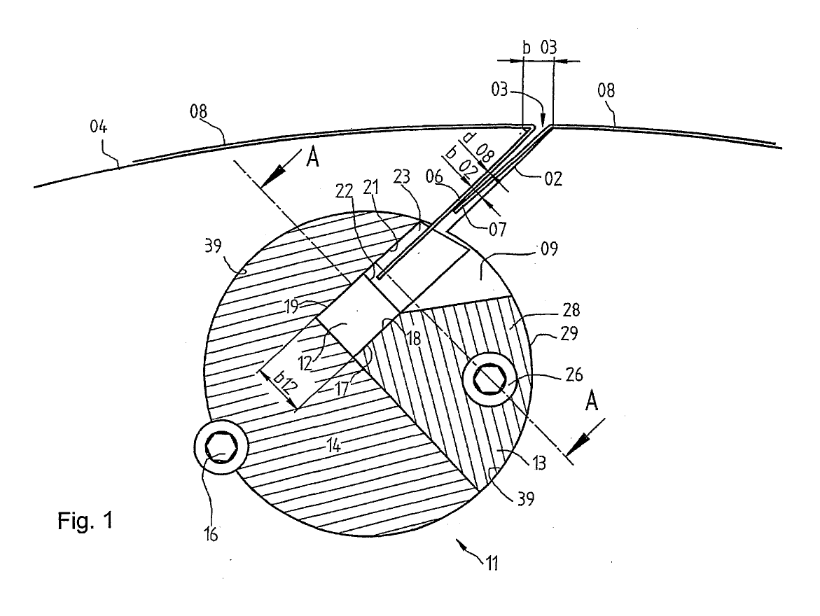

FIG. 1, a schematic representation of the device for the registry-stable placement of a packing on a cylinder,

FIG. 2, a view from above on an area of the printing forme with its cutout,

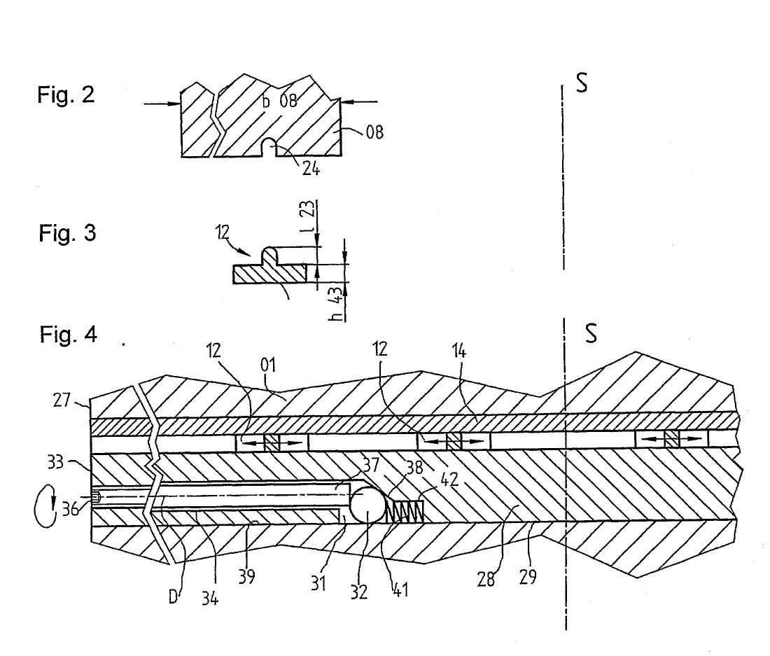

FIG. 3, a lateral view of a register block,

FIG. 4, a longitudinal section through the device for the registry-stable placement of a packing on a cylinder from the plan view A parallel with the groove.

On its circumference, a cylinder 01, for example a forme cylinder 01 of a rotary printing press, has at least one groove 02, extending in the axis-parallel direction, with an opening 03 in the direction toward the shell surface 04 of the cylinder 01, which is used for receiving the ends 06, 07 of one or several packings 08, for example the beveled ends 06, 07 of printing formes 08. In the example, the cylinder 01 is designed as a double-width forme cylinder 01, i.e. four printing formes or newspaper pages can be placed next to each other in the longitudinal direction of the cylinder 01 on its barrel.

In its interior, the forme cylinder 01 has a recess 09, for example a bore 09, extending in the axis-parallel direction and connected with the groove 02, in which the device for registry-stable placement of a packing 08 on a cylinder 01 is arranged. The groove 02, as well as the bore 09, can be provided almost continuous over the entire length of the barrel of the cylinder 01. However, it is also possible for respectively two grooves 02, as well as bores 09, to extend over almost half the length of the barrel and, if desired, to be offset from each other, for example by 180°, in the circumferential direction of the cylinder 01.

In an advantageous design, the groove 02 is embodied as a narrow slit 02, i.e. a slit 02 of a width b02 in the circumferential direction of the cylinder 01, which, in the area of the shell surface 04 of the cylinder 01, is slightly greater than twice the thickness dO8 of the printing forme 08 (for example, b02=2 mm), and whose opening 03 in the direction toward the shell surface 04 has a width b03 of, for example, b03<3 mm. In respect to the shell surface 04 of the cylinder 01 it extends in a secant-like manner, in an advantageous way on the side of the leading end 06 of the printing forme 08, at an acute angle α (for example, 20°<α<50°).

The device for registry-stable placement of a packing 08 on a cylinder arranged in the bore 09 has at least one register element 12, for example a register block 12, and a clamping device 13 working together with the latter, which extends in the bore 09 in an axis-parallel direction and parallel with the groove 02. As a rule, several register blocks 12 are arranged, for example for the alignment of several printing formes 08 located next to each other, each of a width b08. In this case they are arranged next to each other in the longitudinal direction in the bore 09. The register blocks 12 and the clamping device 13 are arranged in an advantageous manner on a support strip 14, also extending in the longitudinal direction of the bore 09. At the front face, the support strip 14 can have a securing device 16 against axial movements and/or pivoting, for example a screw or a pin.

The register block 12 and the clamping device 13 are arranged on the support strip 14, or in the bore 09, in such a way, that a face 17 of the register block 12 acts non-positively together with a face 18 of the clamping device 13 extending in an axis-parallel direction, and a face 19 of the register block 12, which faces away from the face 17, acts non-positively together with a face 21, extending in an axis-parallel direction, of the support strip 14. In the state in which it is not clamped, the register block 12 is arranged so that its position can be changed relative to the clamping device 13 and to the support strip 14 parallel with the groove 02. On its side 22 facing the groove 02, the register block 12 has a protrusion 23, for example a pin 23 or a projection, which acts positively together in respect to an axis-parallel displacement with a cutout 24 in the leading end 06 of the printing forme 08. The register block 13 can be produced as a one-piece T-element, wherein the shape of the protrusion 23 and that of the cutout 24 are matched so they fit into each other. The register block 12 has in an advantageous manner a width b12, which is greater than the width b02 of the groove 02, so that the register blocks 12 are secure against being ejected by the centrifugal forces being created in the course of the rotation of the cylinder 01.

The clamping device 13 has an actuating means 26, which is operated from the front face 27 of the cylinder 01 and which, as a part of a gear arrangement, converts a rotary movement around an axis D extending in the longitudinal direction of the cylinder 01, or a translatory movement in the axis-parallel direction, into a translatory movement of the face 18 in a direction perpendicular to this axis D. The actuating means 26 can be an eccentric shaft, camshaft or profiled shaft of helical cross section, or a threaded spindle, by means of which a keying connection is produced.

In the exemplary embodiment, the clamping device 13 is embodied as a keying connection, which can be operated by means of the actuating means 26, for example a threaded spindle 26, from the direction of the front face 27 of the cylinder 01. It substantially consists of a clamping strip 28 having the face 18 and having a cutout 31 on the face 29, facing away from the face 18 and extending in the longitudinal direction, a ball 32 arranged in the cutout 31, as well as the threaded spindle 26, which is arranged in a bore 34 connecting the cutout 31 and a front face 33 of the clamping strip 28. The bore 34 is supplied, at least partially, with an interior thread and receives the threaded spindle 26. On its first end, for example, the latter has a hexagon socket 36 and, at least in the clamped state, projects with its second end 37 into the cutout 31 and cooperates with the ball 32.

On its side remote from the front face 33, the cutout 31 has a face 38, which is inclined toward the face 29 and opens in the direction toward the center of the cylinder 38. This face 38 works together with the ball 32 and the face 39 of the bore 09, fixed on the cylinder 01, in the manner of a key.

It is possible to arrange a different pressure element 32 in place of the ball 32, which works together with the face 38 and the face 39 of the bore 09, fixed on the cylinder 01. The inclination of the face 38 can also be omitted if the pressure element 32 is embodied in a wedge shape. In the present exemplary embodiment, the threaded spindle 26 as the actuating means 26, the pressure element 32, and at least one inclined face 38 arranged on the pressure element 32 or the clamping strip 28, together constitute the gear arrangement converting the axial movement into a movement perpendicular to it. It is advantageous in connection with the embodiment designed in the stated manner that it is possible by means of the selection of the thread pitch of the threaded spindle 26 and the inclination of the face 38 to set a fine gear ratio and furthermore, that a frictional connection against the unintentional turning of the threaded spindle 26 can be achieved by means of the screw thread. So that in the course of releasing the clamping device 13 the ball 32 dependably moves along the face 38 in the direction of the front face 33 of the clamping strip 28, a spring 41 can be arranged in an axis-parallel extending groove 42 in the face 38.

The arrangement of the cutout 31 and of the pressure element 32 which is pushed off the face 39 of the bore 09, in the longitudinal direction of the cylinder 01 between two register blocks 12 is advantageous. In the example, the cylinder 01 has two clamping devices 13 extending symmetrically in respect to its plane of symmetry S, each of which is operated from the front face, wherein a total of four register blocks 12 are arranged over the length of the barrel on the continuous support strip 14 in the continuous bore 09 (FIG. 3 represents one-half of the symmetrical arrangement).

If the clamping device 13 and the register blocks 12 are not arranged on a support strip 14, but directly in the appropriately shaped recess 09, the face 19 acts directly together with the face 39 of the recess 09 in the clamped state.

The actuating means 26 can also be embodied as a camshaft, for example, which is seated without a screw thread in the bore 34. However, the embodiment as a threaded spindle 26, which has a cam on its end projecting out of the cutout 31, is advantageous in regard to a frictional connection against unintentional reversing of the actuating means 26. In this case the pressure element 32 and the inclined face 38 can be omitted.

It is essential, inter alia, that the clamping device 13 can be operated from the direction of its front face 33, or at least from outside of the printing area of the barrel, and that when the actuating means 26 are operated, the clamping strip 28 is exposed to a movement and/or force component extending almost perpendicularly in respect to the longitudinal direction of the bore 09, in the course of which it maintains the register blocks 12, fixed against an axis-parallel displacement, in a frictionally connected manner between itself and a face 21, fixed on the cylinder (or the face 39 of the bore 09). But in the released state the position of the register blocks 12 can be changed in the axis-parallel direction, or they can be removed, independently of each other without the entire clamping strip 28 or support strip 14 needing to be axially moved. When the register blocks 12 are adjusted, the clamping device 13 and the register blocks 12 are moved relative to each other in the longitudinal direction.

The clamping device 13, and in particular the actuating means 26, can also be operated by means of an appropriate gear arrangement (for example bevel gears, not represented) from the non-printing edge area direction of the shell surface 04, for example in the immediate vicinity of the front face 27.

The face 22 of the register block 12 which faces the leading end 06 of the printing forme 08 in the circumferential direction, can form a detent which can be set by means of the height h43 of a base 43 or the length 123 of the projection 23. A basic setting in the circumferential register can be selected by means of the employment of differently dimensioned register blocks 12.

The device for the registry-stable placement of a packing 08 on a cylinder 01 functions as follows:

In the clamped state, the ball 32 is pressed by means of the threaded spindle 26 in the direction toward the center of the cylinder 01 between the face 39 of the bore 09 and the inclined face 38, and in this way presses the clamping strip 28 into a direction with at least one component which is normal in respect to the face 39 of the bore 09. Thus the register blocks 12 are frictionally connected between the face 21 of the support strip 14 on the one side, and the face 18 of the clamping strip 28 on the other side, fixed against axis-parallel displacement.

For displacing the device, for example for changing the relative distances of the register blocks 12 in respect to each other, the threaded spindle 26, which can be operated from the front face 27 of the cylinder 01, is pivoted in such a way that the frictional connection between the clamping strip 28, the register blocks 12 and the support strip 14 is released, and the register blocks 12 are freed for axis-parallel displacement. For example, the distances between the register blocks 12 can be readjusted by means of a gauge, not represented, inserted into the groove 02. Thereafter the register blocks 12 are again frictionally fixed in place in their new position by turning the threaded spindle 26. With double-width cylinders 01 in particular, i.e. with cylinders 01 on which four printing formes 08 placed side-by-side can be placed for respectively a horizontal or vertical newspaper page, a position change of the register blocks 12 in the longitudinal direction of the cylinder by one-half the width b08 of a packing 08 is for example required when resetting from simple printing formes 08 to so-called panorama plates of almost twice the width is performed.

An exchange, the removal or additional equipping the device with register blocks 12 is also possible in a simple manner in that, following the release of the threaded spindle 26, either the register blocks 12 are pushed out of the front of the device or, following the additional release of the securing device 16, the entire device, consisting at least of the clamping strip 28 and register blocks 12, is pulled out of the bore 09 from the front of the cylinder 01.

List of Reference Symbols

01 Cylinder, forme cylinder

02 Groove, slit

03 Opening (02)

04 Shell surface (01)

05 -

06 End, leading (08)

07 End, trailing (08)

08 Packing, printing forme

09 Recess, bore (01)

10 -

11 -

12 Register element, register block

13 Clamping device

14 Support strip

15 -

16 Securing device

17 Face (12)

18 Face (13)

19 Face (12)

20 -

21 Face (14)

22 Face (12)

23 Protrusion, pin (12)

24 Cutout (08)

25 -

26 Actuating means, threaded spindle (13)

27 Front face (01)

28 Clamping strip (13)

29 Face (28)

30 -

31 Cutout (29)

32 Ball, pressure element

33 Front face (28)

34 Bore (28)

35 -

36 Hexagon socket

37 End (26)

38 Face, inclined (31)

39 Face (09)

40 -

41 Spring (28)

42 Groove (28)

43 Base (12)

b02 Width (02)

b03 Width (03)

b08 Width (08)

b12 Width (12)

d08 Thickness (08)

h43 Height (43)

123 Length (23)

A Axis

D Axis

S Plane of symmetry

α Angle

1. A device for placing at least one registry-stable packing (08) on the shell surface (04) of a cylinder (01) of a rotary printing press, wherein the device has at least one register block (12), whose position can be changed in the longitudinal direction of the cylinder (01), and a clamping device (13) for the register block (12), whose clamping point is arranged inside the barrel of the cylinder (01) and by means of which the register block (12) can be fixed in place in respect to a position change in the longitudinal direction of the cylinder (01), characterized in that the clamping device (13) can be actuated from outside of the printing area of the barrel of the cylinder (01).

2. The device in accordance with claim 1, characterized in that the position of the register block (12) can be continuously changed by at least one-half of a width (b08) of a packing (08) extending in the longitudinal direction of the cylinder (01).

3. A device for placing at least one registry-stable packing (08) on the shell surface (04) of a cylinder (01) of a rotary printing press, wherein the device has at least one register block (12) and the packing (08) has a width (b08) extending in the longitudinal direction of the cylinder (01), characterized in that the position of the register block (12) in the longitudinal direction of the cylinder (01) can be continuously changed by at least one-half of a width (b08) of the packing (08) extending in the longitudinal direction of the cylinder (01).

4. The device in accordance with claim 3, characterized in that the register block (12) works together with a clamping device (13) which can be actuated from outside of the printing area of the cylinder (01), by means of which the register block (12) can be fixed in place in respect to a position change in the longitudinal direction of the cylinder (01), and wherein the clamping point is arranged inside the barrel of the cylinder (01).

5. The device in accordance with claim 1 or 3, characterized in that the device has at least two register blocks (12), which are arranged next to each other in the longitudinal direction of the cylinder (01).

6. The device in accordance with claim 1 or 3, characterized in that a plurality of clamping blocks (12) is arranged so they work together with a single clamping device (13).

7. The device in accordance with claim 1 or 4, characterized in that the clamping device (13) can be actuated from the front face (27) of the cylinder (01).

8. The device in accordance with claim 1 or 4, characterized in that the position of the register block (12) in the longitudinal direction of the cylinder (01) can be changed independently of a movement of the clamping device (13) in the longitudinal direction of the cylinder (01).

9. The device in accordance with claims 5 and 6, characterized in that at least two clamping devices (13) are arranged in the longitudinal direction of the cylinder (01).

10. The device in accordance with claims 1 or 4, characterized in that the clamping device (13) has a clamping strip (28) acting together with the register block (12) and an actuating means (26), by means of which the clamping strip (28) can be placed against, or away from the register block (12) in a direction which is almost perpendicular to the longitudinal direction of the cylinder (01).

11. The device in accordance with claim 10, characterized in that the clamping device (13) is embodied as a keying connection in regard to the clamping strip (28) and the register block (12), wherein faces (21, 29) fixed on the cylinder constitute an abutment on both sides, and wherein the keying connection can be set by means of the actuating means (26) on the front face of the cylinder (01).

12. The device in accordance with claim 11, characterized in that the actuating means (26) are embodied as a threaded spindle (26) extending almost in the longitudinal direction of the cylinder (01), by means of which the clamping strip (28) can be displaced via the keying connection in a direction extending almost perpendicular in respect to the longitudinal direction of the cylinder (01).

13. The device in accordance with claim 1 or 3, characterized in that the device is arranged in a recess (09) extending in the longitudinal direction of the cylinder (01), wherein a groove (02), which connects the shell surface (04) and the device and extends in the longitudinal direction of the cylinder (01), receives a leading (06) and trailing end (07) of the packing (08).

14. The device in accordance with claim 13, characterized in that the leading end (06) of the packing (08) has a cutout (24) which acts together with a protrusion (23) assigned to the register block (12).

15. The device in accordance with claim 13, characterized in that the groove (02) extends in a secant-like manner on the circumference of the cylinder (01), in an advantageous manner on the side of the leading end (06) of the packing (08) at an acute angle (a), and that the groove (02) on the shell surface (04) has a width (b03) of an opening (03) in the circumferential direction of the cylinder (01) which is less than 3 mm.

16. The device in accordance with claim 2 or 3, characterized in that the barrel of the cylinder (01) has a width corresponding at least to the width of two packings (08) arranged side-by-side in the longitudinal direction of the cylinder (01).

17. The device in accordance with claim 2 or 3, characterized in that the barrel of the cylinder (01) has a width corresponding at least to the width of four packings (08) arranged side-by-side in the longitudinal direction of the cylinder (01).

18. The device in accordance with claim 17, characterized in that the position of the register block (12) can be changed by almost one-half of the width of the barrel of the cylinder (01).

19. The device in accordance with claim 13, characterized in that the width (b12) of the register block (12) is greater than the width (b02) of the groove (02).
